(19) United States
(12) Patent Application Publication
(10) Pub. No.: US 2026/0321989 A1
(43) Pub. Date: Oct. 15, 2026

(54) LOW-LOSS DIELECTRIC LATTICE-BASED SUPERSTRATES AND METHODS FOR PRODUCING THE SAME

(71) Applicant: 3DFortify Inc., Boston, MA (US)

(72) Inventors: Philip Lambert, Cambridge, MA (US); Colby Hobart, Shrewsbury, MA (US); Joshua A. Martin, Boston, MA (US)

(21) Appl. No.: 19/106,576

(22) PCT Filed: Aug. 25, 2023
(86) PCT No.: PCT/US2023/072964

§ 371 Date: Feb. 25, 2025

Related U.S. Application Data
(60) Provisional application No. 63/401,124, filed on Aug. 25, 2022.

(51) Int. Cl. H01Q 15/08; B33Y 10/00; H01Q 1/42

(52) U.S. Cl. CPC H01Q 15/08; B33Y 10/00; H01Q 1/422

(57) ABSTRACT

Superstrates made from a base low-loss dielectric material(s) that can be used as low-loss antenna matching superstrates are provided. The superstrates can be latticed wide-angle impedance matching (WAIM) superstrate, which can minimize, or even eliminate the negative impact of any reflections that may occur during steering antennas. The superstrates can mimic other structures to exhibit behaviors similar to those structures. For example, the values of the dielectric constant can be varied by way of optimization of the geometry of the superstrate, which can allow formation of superstrates having non-uniform, as well as uniform, dielectric constants across a body thereof. In some embodiments, the superstrates can be arcuate to allow for use in lenses and/or radomes paired with radio frequency (RF) antennas.

### CROSS REFERENCE TO RELATED APPLICATION

The present disclosure claims priority to U.S. Provisional Application No. 63,401/124, entitled “Low-Loss Dielectric Lattice-Based Superstrates and Methods for Producing the Same,” which was filed on Aug. 25, 2022, and which is incorporated by reference herein in its entirety.

### FIELD

The present disclosure relates to utilizing additive manufacturing to produce low-loss dielectric lattice-based superstrates, and more particularly relates to producing such superstrates for use as impedance matching for radio frequency (RF) devices such as steerable phased or array antennas.

### BACKGROUND

Phased array antennas are electronically steered by varying the delay of a radiated signal to each of the antenna elements and/or sections independently and likewise on the receive path back to the radar front end. Over the steering range, there is a non-uniform reflection (S-parameter S11) based on the scan angle away from boresight of the steering.

Larger reflections are induced at the larger scan angles, making parts of the scan aperture unusable in many systems.

Attempts to negate the occurrence and/or impact of the larger reflections have included the creation and/or implementation of wide-angle impedance matching (WAIM) and/or matching superstrates, but with a limited tool set. Some level of performance is available for designs using planar sheets of material at a set dielectric constant based on availability. An effective dielectric constant can be altered in these planar sheets, for example, by drilling hundreds to thousands of holes in different layers. Such actions, however, can be time consuming, provide for much wasted material, and do not generally represent a sophisticated and/or desirable manufacturing technique, among other drawbacks appreciated by those skilled in the art. It may also be possible to do some planar designs with different densities of radio frequency (RF) foam cores, but even to the extent this is possible, limiting factors include there being few set available densities and their large tolerances.

Accordingly, there is a need for ways to improve the use and performance of phased array antennas so that the negative impact of any reflections that may occur during steering are minimized or even eliminated.

### SUMMARY

The present disclosure is directed to producing a supersubstrate, or superstrate, using lattice structures made of one or more low-loss materials. The production can occur, for example, through various additive manufacturing techniques, such as vat polymerization techniques like digital light processing (DLP). With the ability to print lattice structures in a number of low-loss materials, a supersubstrate can be printed with regions of a different discreet, or a variable effective dielectric constant, allowing for a single-print, single-material solution to uniform impedance matching across the scan angle. Because the 3D-printed superstrate can utilize selective effective Dk over complex shapes, the superstrate can correct for impedance matches based on angle from boresight in a truly fluid solution. Thin, solid dielectric skins can also be created on the surfaces of the superstrate. These skins can protect the lattice structures, as well as become a landing area for metallization.

The disclosures herein allow for fine tuning of the effective dielectric constant anywhere in the device, which itself can take on a wide range of shapes. That is, different layers of discrete effective Dk can be different thicknesses in different areas and the whole device can take on a curved or other shape to conform to the antenna array landscape.

One exemplary embodiment of a low-loss, lattice-based superstrate includes a plurality of layers that comprise a mix of low-loss dielectric material and air. Dielectric constant values for a single layer of the plurality of layers is varied by way of a volume fraction of the mix of low-loss dielectric material and air across a volume of the superstrate, and dielectric constant values for the superstrate are varied across a volume of the superstrate by way of the volume fraction of the mix of low-loss dielectric material and air.

The superstrate can include a plurality of discrete regions, with each region of the plurality of discrete regions having a different dielectric constant value. The plurality of layers form a lens that can be configured to be paired with a radio frequency device. The lens can be a gradient refractive index (GRIN) dielectric lens. In some embodiments, the lens can be configured to be enhance or manipulate a strength of a beam to which the lens is coupled.

In some embodiments, a solid skin can be coupled to at least a portion of a periphery of the plurality of layers. The solid skin can provide a landing area for metallization. The superstrate can have an arcuate outer layer having a radius of curvature. In some embodiments, the superstrate can be configured to provide wide-angle impedance matching (WAIM) superior to that of a traditional wide angle matching superstrate. A scan angle of a phased array that includes the superstrate can be at least about 70 degrees from boresight.

An effective relative permittivity rate of the superstrate can be approximately 1.15 or lower. In some embodiments, an effective relative permittivity rate of the superstrate can be approximately 1.1 or lower. An effective dielectric value of the superstrate can be approximately in the range of about 1.1 Dk to about 2.8 Dk. The superstrate can be configured to withstand a temperature of at least about 250 °C. Each layer of the plurality of layers can be formed from a plurality of gyroid structures. The dielectric constant values for the superstrate can form a uniform value across the plurality of layers.

One exemplary method for printing a superstrate includes additively manufacturing a superstrate that includes a plurality of layers that comprise a mix of low-loss dielectric material and air, with the superstrate being a lens. Dielectric constant values for a single layer of the plurality of layers are varied by way of a volume fraction of the mix of low-loss dielectric material and air across a volume of the plurality of layers, and dielectric constant values for the superstrate are varied across a volume of the superstrate by way of the volume fraction of the mix of low-loss dielectric material and air.

Additively manufacturing the superstrate can further include forming a plurality of discrete regions of the superstrate, with each region of the plurality of discrete regions having a different dielectric constant value. In some embodiments, additively manufacturing a superstrate can further include varying an effective dielectric constant value of the superstrate by using gyroids having different dielectric constant values at different locations of the plurality of gyroid layers. Dielectric constant values for the superstrate being varied across the volume of the superstrate can further include matching the dielectric constant values for the superstrate to a dielectric constant values of a material for a frequency of interest. In some embodiments, the dielectric constant values for the superstrate can form a uniform value across the plurality of layers. Dielectric constant values for the plurality of layers can transition along an effective gradient that tapers continuously across the plurality of layers. In some embodiments, dielectric constant values for the superstrate can transition along an effective gradient that tapers continuously across the substrate.

In some embodiments, the method can further include placing the lenses in front of a generated beam to enhance or manipulate a strength of the beam. In some embodiments, the method can further include coupling a solid skin to at least a portion of a periphery of the plurality of layers of the superstrate. The superstrate can include an arcuate outer layer having a radius of curvature.

### BRIEF DESCRIPTION OF THE DRAWINGS

This disclosure will be more fully understood from the following detailed description, taken in conjunction with the accompanying drawings, in which:

FIG. 1 is a perspective view of a gyroid structure for use in forming structures of the present disclosure and a perspective view of a solid, rectangular prism structure having a corresponding effective dielectric constant (Dk) value as the gyroid structure;

FIG. 2 illustrates perspective views of three gyroid structures, each structure having a different effective Dk realized through different wall thicknesses for each gyroid structure;

FIG. 3A is a schematic cross-sectional view of an embodiment of a superstrate of the prior art disposed above an antenna;

FIG. 3B is a schematic cross-sectional view of an embodiment of a superstrate of the present disclosure disposed above an antenna;

FIG. 4A includes perspective views of exemplary embodiments of antennas and arrays to which the superstrates of the present embodiments can be applied;

FIG. 4B includes perspective views, a schematic top view (switched beam array 814), and a top view (Vivaldi antenna 816) of additional exemplary embodiments of antennas and arrays to which the superstrates of the present embodiments can be applied;

FIG. 4C includes perspective views and a top view (bowtie antenna 820) of additional exemplary embodiments of antennas and arrays to which the superstrates of the present embodiments can be applied;

FIG. 5A includes perspective views of exemplary embodiments of lenses that can be formed from the superstrates of the present embodiments;

FIG. 5B includes perspective views of exemplary embodiments of lenses that are formed from the superstrates of the present embodiments;

FIG. 6 is a perspective view of an embodiment of a constant-K lens of the present embodiments paired with a Vivaldi antenna;

FIG. 7 is a perspective view of exemplary embodiments of radomes that can be formed from the superstrates of the present embodiments;

FIG. 8A is a perspective view of one embodiment of a printing apparatus that can be used to print the structures of the present disclosure, and thus the objects that include the structures of the present disclosure; and

FIG. 8B is a side view of the printing apparatus of FIG. 8A having a side panel of a housing removed to illustrate components of the printing apparatus disposed within the housing.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings and/or are described herein. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. Terms commonly known to those skilled in the art may be used interchangeably herein, including but not limited to additive manufacturing and 3D printing. Moreover, to the extent the terms “antenna” and “lens” are used in this specification, the terms are meant to provide examples of a radio frequency (RF) devices, and that a person skilled in the art will recognize that the teachings with respect to the antenna(s) and lens(es) can apply to other RF devices, components, and systems, such as dielectric resonators, foams, radomes, switched beam arrays, frequency selective surfaces, wide angle impedance matching layers, and phased arrays.

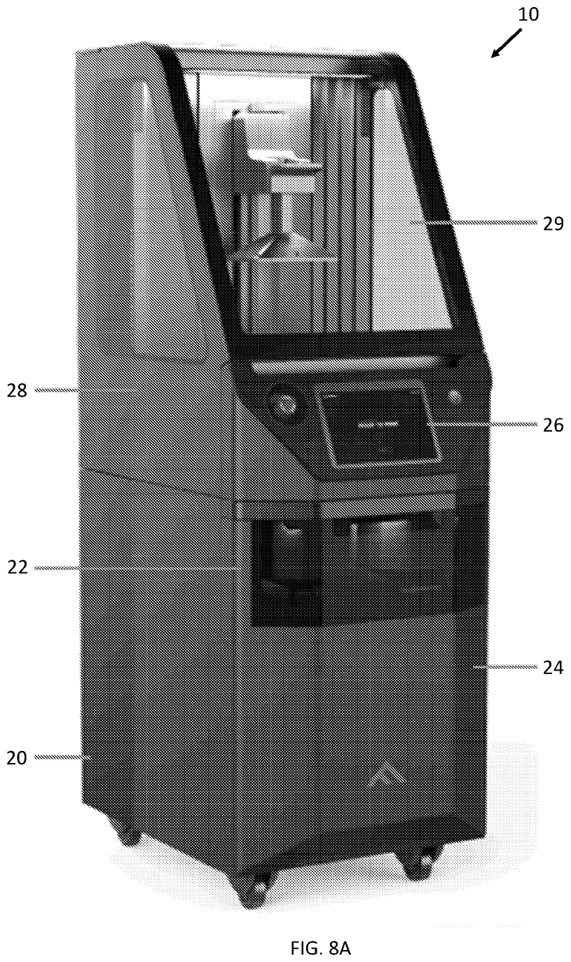

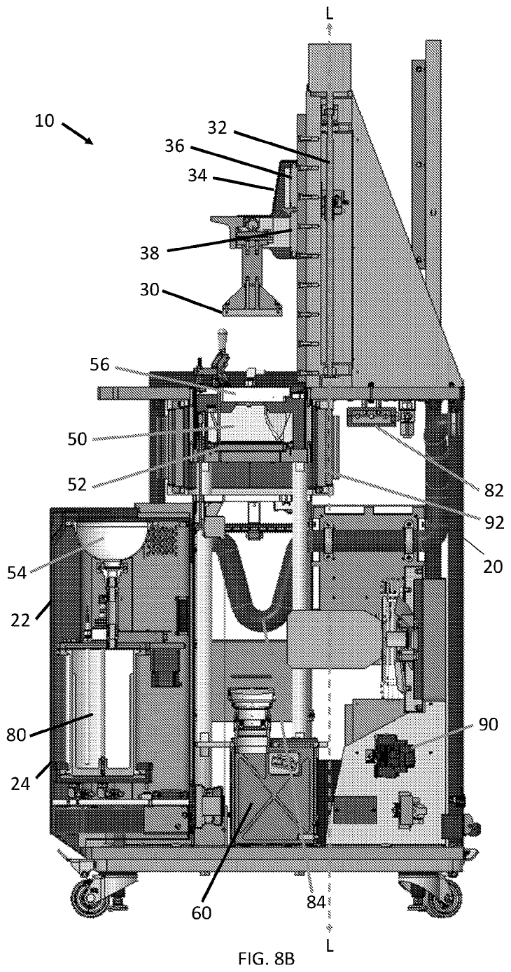

Because a person skilled in the art will generally understand how stereolithography (SLA), masked stereolithography (MSLA), and digital light processing (DLP) additive manufacturing works, the present disclosure does not provide all details related to the same. A person skilled in the art will understand how to produce the structures and objects provided for herein using vat polymerization procedures, including but not limited to SLA, MSLA, and DLP processes and SLA, MSLA, and DLP printers. Some non-limiting examples of DLP printers and techniques with which the present disclosures can be used include those provided for in U.S. Pat. No. 10,703,052, entitled “Additive Manufacturing of Discontinuous Fiber Composites Using Magnetic Fields,” U.S. Pat. No. 10,732,521, entitled “Systems and Methods for Alignment of Anisotropic Inclusions in Additive Manufacturing Processes,” and the FLUX 3D printer series, including the FLUX ONE and FLUX CORE 3D printers, manufactured by 3DFortify Inc. of Boston, MA (further details provided for at http://3dfortify.com/and related web pages), the contents of all being incorporated by reference herein in their entireties. Additional disclosures about a non-limiting embodiment of a DLP printer are provided with respect to FIGS. 8A and 8B herein.

The present disclosure generally relates to the creation of superstrates using additive manufacturing techniques, such as vat polymerization (e.g., DLP). The superstrates can be made from a base low-loss dielectric material(s) and can be used as low-loss antenna matching superstrates. This dielectric can be manipulated in 3D unit-cells that mix a percentage of dielectric and air to create an effective dielectric constant (Dk) and effective dielectric loss tangent (Df) in that area. These effective Dk and Df areas can apply to different areas and thicknesses of the device, which can contain many different regions of effective Dk and Df, or a gradient of those parameters across an area.

At least one novel aspect of the superstrates of the present embodiments includes minimization, or even elimination, of the negative impact of any reflections that may occur during steering antennas. Reflections can be minimized, for example, by varying values of the dielectric constant across a volume of the superstrate. The values of the dielectric constant can be varied by adjusting a volume fraction of solid-to-air across a volume of the superstrate, which can allow for a formation of a superstrate(s) having non-uniform dielectric constants across a body of a printed object. In other embodiments, the values of the dielectric constant can be varied by adjusting a volume fraction of solid-to-air across a volume of the superstrate that includes at least a portion of a body of a printed object, or in some cases, an entire body of the printed object, such that a uniform, or substantially uniform (e.g., within about 5%) dielectric constant can be formed in that portion of the body, or in the entire body of the printed object. That is, in some embodiments, the portion of the body in which the uniform, or substantially uniform dielectric constant can be formed can include the entire body of the printed object. In some embodiments, printed objects can include some portions of a body of the printed object with constant, uniform dielectric constants across a portion of the body while other portions of the body have non-uniform dielectric constants across a portion of the body.

The superstrates of the present embodiments can include structures that may be broader than those that a person skilled in the art would consider to encompass a superstrate. Specifically, for the purposes of this disclosure, to the extent the term “superstrate” is used in this specification, it refers to any non-air or non-vacuum device or substance that resides between an antenna and free space and thus modulates the antenna beam in some way. The term is meant to provide an example of a component that covers either passive elements or active elements of an antenna or radar system, and that a person skilled in the art will recognize that the teachings with respect to the superstrate can apply to other elements of RF devices, such as a substrate, as well as other devices, such as lenses, wide-angle impedance matching layers, radomes, and dielectric resonators. The present disclosure provides for the ability to tailor the effective dielectric constant and/or loss tangent for impedance modulating and/or impedance matching, which can be applied in the RF chain prior to the antenna in a number of ways. Transmission lines can be made lower loss, filter resonances can have tighter control and/or increased bounds, and in-circuit cavities can use impedance tapers that were not previously possible. Waveguide transitions can also have lower reflection transitions with ramped dielectric constant. Some non-limiting examples of superstrates can include a spherical lens, a cylindrical lens that sits inside a resonant cavity, a non-uniform lens coupled to a phased array, and/or conformal lens that sits within a radome or serves a radome, among others. Further non-limiting superstrate examples include graduated dielectric constant wide angle impedance matching, smart radomes with tapered Dk transitions for lower reflection, and/or oversteering lenses for wider scan angle in phased arrays.

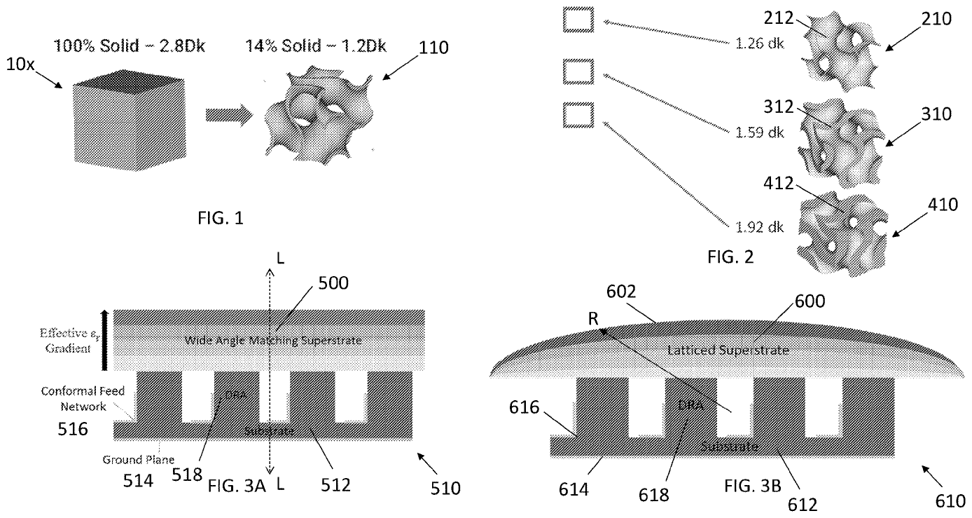

The dielectric/air mix can be achieved using a number of structures, including a repeating gyroid pattern. In some embodiments, an effective relative permittivity rate of the superstrate can be approximately in the range of about 1.1 to about 2.1, depending, at least in part, on the frequency, and a low end of the range can be approximately in the range of about 1.1 to about 1.3, as governed, at least in part, by frequency. A relative permittivity as low as about 1.1 for low RF performance can be achieved by the present disclosures, and a relative permittivity as low as about 1.15 for higher military radar frequencies can be achieved by the present disclosures. However, this metric is a trade-off with mechanical strength, so a higher relative permittivity can allow for a higher strength device. FIG. 1 illustrates one exemplary embodiment of a gyroid structure 110 used to form a superstrate. As shown, the gyroid structure 110 is about 14% solid and has a Dk value of about 1.2 Dk. By way of comparison, a solid, rectangular prism structure 10x is provided, is 100% solid, and has an effective Dk value of about 2.8 Dk. An effective dielectric value of the structures that are part of the present disclosures can be approximately in the range of about 1.1 Dk to about 2.2 Dk, and in some embodiments can include a discrete step to at least about 2.8 Dk, thus allowing for an approximate range of about 1.1 Dk to about 2.8 Dk. The resulting superstrate can be able to withstand temperatures of about 250 °C or greater.

FIG. 2 provides three gyroid structures 210, 310, 410, each having different configurations, resulting in each having a different effective Dk value. Changing a wall thickness of the respective gyroid patterns of the structures 210, 310, 410 can increase or decrease the effective Dk value of that region. More particularly, as shown, the structure 210 has walls 212 having a thickness that is less than a thickness of walls 312 of the structure 310, which themselves have a thickness that is less than a thickness of walls 412 of the structure 410. Even in the same gyroid structure, some walls may have different thicknesses and/or thickness that varies across a length and/or width of a wall. The ability to control certain portions of an object being printed to have different dielectric constants across its surface area, layers, volume, etc. can be useful in providing a more finely tuned, capable, and versatile device. Additional information about printing RF devices using gyroid structures is provided for at least in U.S. patent application Ser. No. 17/274,406, entitled “Systems and Methods for Designing and Manufacturing Radio Frequency Devices,” filed Apr. 13, 2022, and the contents of which is incorporated by reference herein in its entirety.

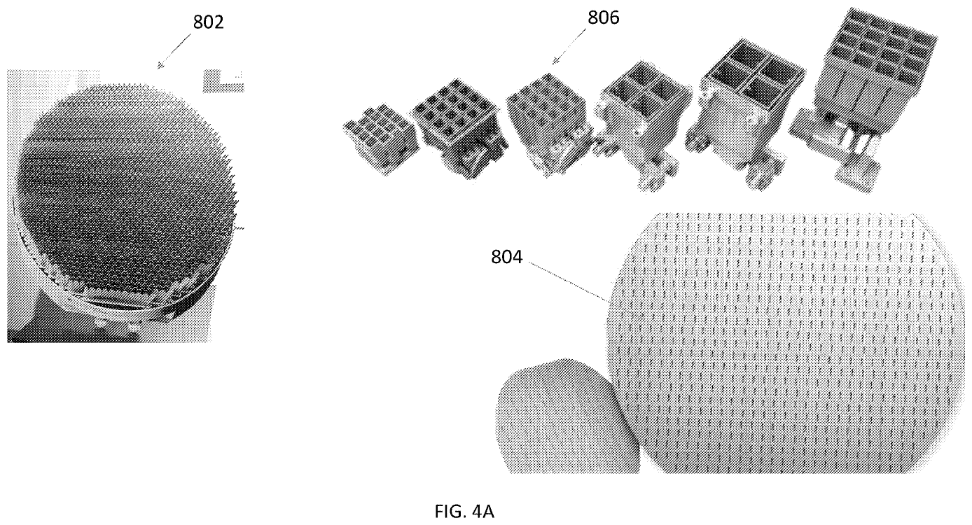

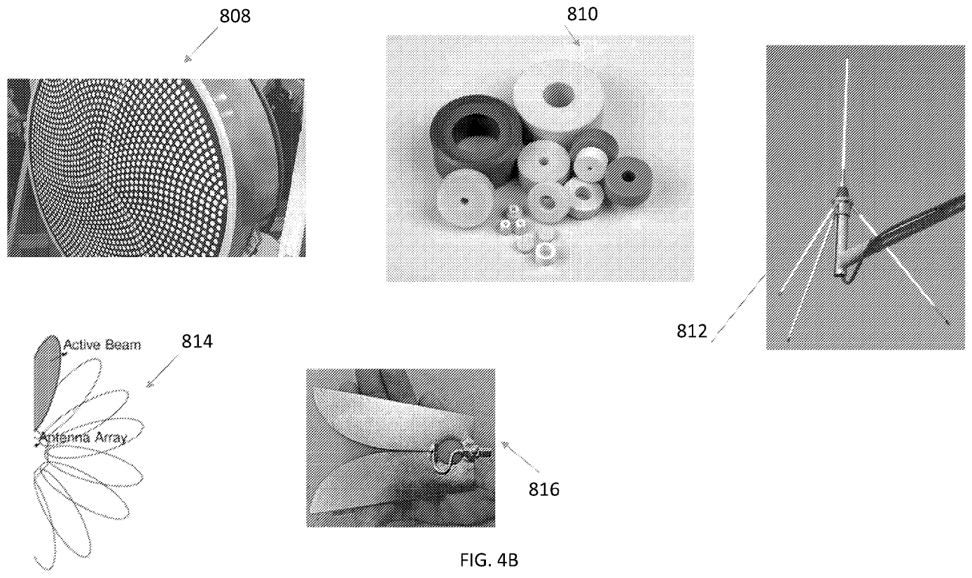

FIG. 3A illustrates one embodiment of a standard brick wide-angle impedance matching (WAIM) superstrate 500 of the prior art mounted above an array antenna 510. As shown, the superstrate 500 can be disposed above a substrate 512. The substrate 512 is disposed on a ground plane 514, and includes a conformal feed network 516 and a plurality of dielectric resonator antenna (DRA) 518. The superstrate 500 can have an effective gradient that changes from layer-to-layer. Because of the limited of current manufacturing techniques, however, the superstrate 500 remains substantially flat, and at best may be able to be slightly curved. It is limited in conformity, sitting substantially perpendicular to a central longitudinal axis L of the antenna 510. Additionally, a thickness of the layers of the superstrate 500 cannot easily vary either the available Dk or the effective Dk based on available materials. Still further, complex shapes and patterns of areas of effective Dk are not possible using existing techniques for producing superstrates like the superstrate 500.

FIG. 3B illustrates one embodiment of a latticed wide-angle impedance matching (WAIM) superstrate 600 in accordance with the present disclosures mounted above an array antenna 610. As shown, the superstrate 600 can be disposed above a substrate 612. The substrate 612 can be disposed on a ground plane 614, and includes a conformal feed network 616 and plurality of DRA 618. The superstrate 600 can have an effective gradient that changes from layer-to-layer. In some embodiments, the effective Dk can transition along an effective gradient that tapers continuously, or substantially continuously (i.e., continuous at least about 90% of the time), across the superstrate 600. Put another way, the superstrate 600 can include one or more transitions or transition regions where differences in Dk from one unit cell to an adjacent unit cell can be less than about 10%, for example. A rate of change can be varied with the superstrate 600 of the present embodiments with far more control than with conventionally manufactured superstrates. In view of the present disclosures, more complex shapes of superstrates are possible, including superstrates that are substantially more curved than possible in the prior art, as illustrated by the curved nature of the superstrate 600 in comparison to the superstrate 500. Conformity is not as limited in view of the present disclosures, thus allowing for a radius of curvature R to be formed by an outer layer 602 of the superstrate 600. The outer layer 602 can be considered arcuate, as can other layers interlayers of the superstrate 600. Further, a thickness of the layers of the superstrate 600 can vary both with respect to the available Dk and/or the effective Dk based on available materials. The superstrate 600 can be described as a panel having different, unique layers of lattice that form the superstrate 600. The superstrate 600 can be achievable for the S, C, X, Ku, or Ka band. Still further, complex shapes and patterns of areas of effective Dk can be achieved by producing the superstrate 600 using gyroids, mixing air and material (e.g., low-loss dielectric material), via additive manufacturing. Thin, solid dielectric skins can also be created on the surfaces of the superstrate 600. The skin can be coupled to at least a portion of a periphery of the layers that form the superstrate 600.

The superstrate 600 can allow for better matching of antenna impedance to free space at wide angles. It can also reduce scan loss and increase scan angle of phased arrays (e.g., 70 degrees from boresight). The superstrate 600 can retrofit to existing equipment (e.g., existing array antennas), and it can be low profile, thus providing for a low profile overall structure, the structure being, for example, the antenna 610 and the superstrate 600.

It will be appreciated that in some embodiments, the superstrates of the present embodiments can be used as substrates.

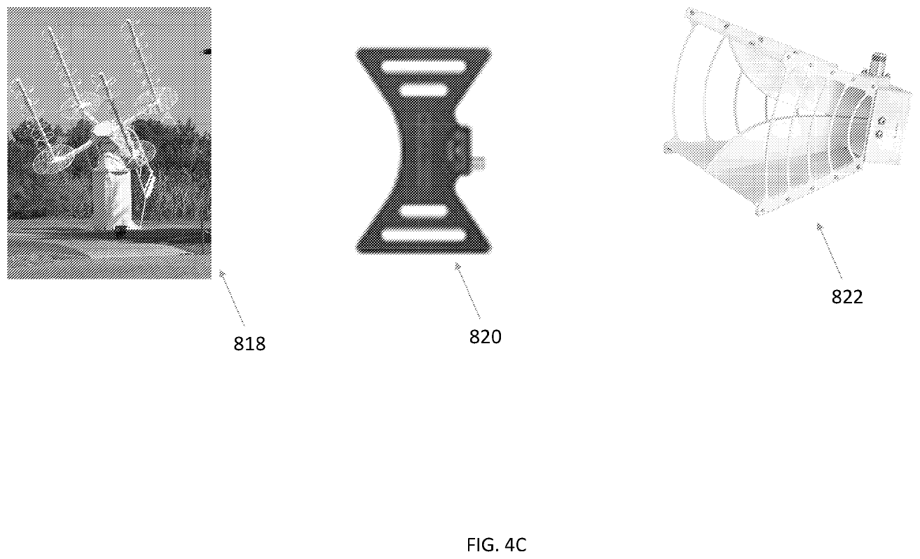

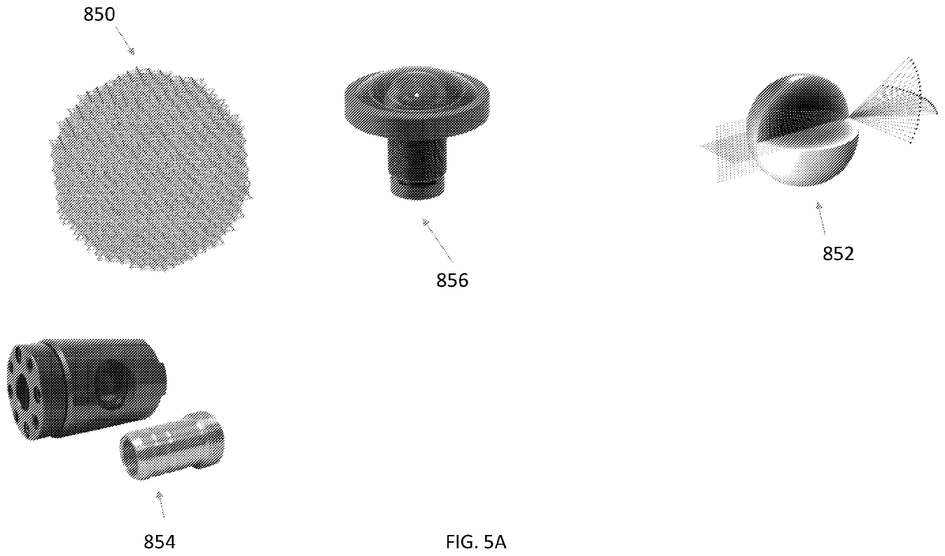

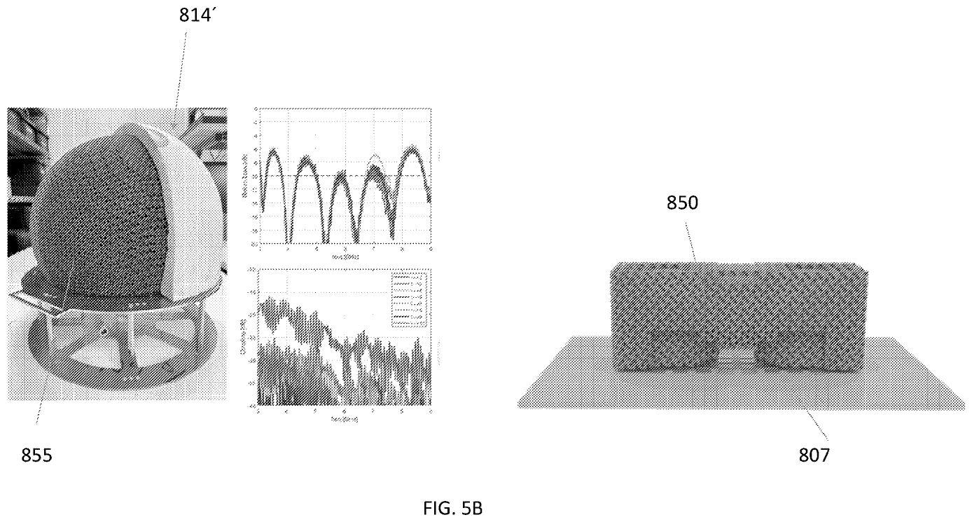

The WAIM superstrates of the present embodiments can be used in conjunction, e.g., be paired, with a wide variety of antennas. For example, some non-limiting examples of antennas that can be addressed with the WAIM superstrates of the present embodiments are shown in FIGS. 4A-4C. These can include, by way of non-limiting examples: image active electronically scanned arrays (AESAs) 802; waveguide phased array antennas, such as slotted waveguide phased array antennas 804; horn arrays and/or horn phased arrays 806; phased arrays, such as active phased arrays 808; dielectric resonators 810; monopoles/dipoles 812; switched beam arrays 814; and/or wideband antennas (such as Vivaldi antennas 816, spiral antennas 818, bowtie antennas 820, dual ridged horn antennas 822, and/or arrays combining one or more of the same. In some embodiments, the WAIM superstrate can be applied to any of the above antennas as an array to provide one or more advantages, such as those provided for herein or otherwise understood by a person skilled in the art in view of the present disclosures. The superstrates of the present embodiments can be applied to any of these types of antennas and/or arrays illustrated in FIGS. 4A-4C, as well as other antenna, arrays, etc. known to those skilled in the art, by a person skilled in the art in view of the present disclosures. Moreover, a person skilled in the art will appreciate the functions, operations, configurations, and details, e.g., shapes and/or construction, of the antennas and/or arrays discussed herein, and thus a detailed discussion of the same is omitted herein for the sake of brevity.

For example, with respect to active phased arrays 808, the WAIM superstrates of the present embodiments can mimic, or behave similarly to, one or more properties of an artificial dielectric to exhibit one or more properties thereof. An example of such an advantage is that anisotropic dielectrics can be built by simply stacking layers of different homogeneous materials with sub-wavelength thickness. An artificial anisotropic material can therefore be realized stacking two different materials along the z-direction (i.e., normal to the material surface), which are characterized by two different permittivities and thicknesses to form a unit cell that is repeated in one dimension. The techniques of the present embodiments can be leveraged to additively manufacture the WAIM superstrate having this advantage. For example, the Dk of the WAIM superstrate can be varied across a volume thereof to create an anisotropic structure in a given direction by way of a geometry of the superstrate, as discussed further below.

The antennas and/or arrays discussed above can be augmented in a variety of ways. One example of the more complex shapes supported by the superstrates of the present embodiments can include the curved shapes of lens or a lens antenna that is paired with the antenna embodiments discussed above to create a superstrate that is spaced equidistantly, or substantially equidistantly, from the curved lens for maximum performance, or even a curved superstrate that is changing its distance from the lens or antenna based on x/y axes position to provide different augmentation and/or impedance matching at different portions of a beam or scan angle. Additional benefits of configurations provided for herein can include increase gain, reduce side lobes, improve field of view, and/or provide the same performance with few power requirements, as examples. In some embodiments, the lenses can be objects that can be placed in front of a generated beam to enhance and/or manipulate a strength of the beam. The lenses of the present embodiments can be wideband to allow for pairing with one or more of the antenna embodiments discussed above. One exemplary embodiment of such a lens can include a gradient refractive index (GRIN) dielectric lens or GRIN lens 850. GRIN dielectric lens (or lens antenna) 850 is a type of dielectric metastructure with a continuous spatially graded index of refraction, which can allow for some control of the electromagnetic radiation passing through the structure. In short, GRIN dielectric lenses/antennas 850 can be used to greatly alter the performance of an antenna by modifying/augmenting the gain, directivity, antenna pattern, steering angle, bandwidth, and/or other key antenna parameters. The wideband GRIN lenses of the present embodiments may be able to be used in conjunction, e.g., be paired, with wideband antennas to provide wide-angle impedance matching, beam focusing, and/or beam steering. In at least some instances, this may require many matching layers to achieve broad bandwidth in a dielectric-only approach, which may be achievable in view of the present disclosures and knowledge of a person skilled in the art. The GRIN lenses 850 of the present embodiments can be used in military/defense, aerospace/space, commercial 5G telecommunications, satellite communications (SATCOM), and/or various sensor applications. Additional aspects and features of GRIN lenses are understood by a person skilled in the art, and thus they are not included for brevity. A person skilled in the art, in view of the present disclosure, will understand how the superstrates provided for herein can be used in conjunction with many varieties of GRIN lenses.

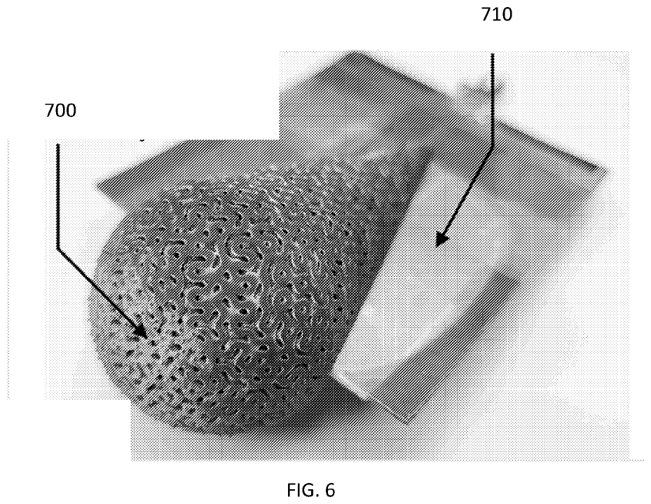

The techniques of the present embodiments can allow for cost-effective fabrication of complex GRIN lenses. For example, the WAIM superstrates disclosed above can be printed as extremely intricate and high resolution GRIN lenses 850 that operate well at microwave/mm-wave frequencies. These lenses, which are extremely difficult to manufacture using traditional methods, can provide substantial antenna gain in a relatively compact shape and with minimal weight. Some non-limiting examples of GRIN lenses that can be manufactured with the techniques of the present embodiments can include: field of view enhancing lenses; Luneburg lenses 852; dispersive lenses; focusing lenses; beam splitting lenses 854; multi-beam lenses; switched beam antenna lenses; Maxwell fisheye lenses 856; compressed lenses; quasi transformation optics based lenses; cylindrical lenses; low-profile lenses; aperture lenses; constant-K lenses 700 (shown in FIG. 6); and/or sidelobe reducing lenses, among others, some non-limiting examples of which are shown in FIG. 5A. The superstrates of the present embodiments can be applied to any of these types of lenses by a person skilled in the art in view of the present disclosures.

It will be appreciated that the shape of the superstrates of the present embodiments can deviate from that of the superstrate 600 shown in FIG. 3B to accommodate a shape of the array that is addressed. As mentioned above, customizability of a parameter, such as shape, can be performed with far more control on the superstrate 600 of the present embodiments than on conventionally manufactured superstrates. For example, as shown in FIG. 5B, a shape of a printed lens 855, as shown a Luneburg lens, on a switched beam array 814′ or a lens 850 on the phased array 807 can differ from that of the superstrates of the present embodiments. In the illustrated embodiments, each of the lens 855 of the switched beam array 814′ and the lens 850 of the phased array 807 are printed using superstrates of the present disclosure. More particularly, the embodiments of FIG. 5B were printed using Radix™ printable dielectric material (e.g., 2.8 Dk), provided by Rogers Corporation (Chandler, AZ) as the material and an additive manufacturing printer from Fortify Inc. (Boston, MA) (e.g., the FLUX ONE), an example of one such printer which is described below with respect to FIGS. 8A and 8B. Moreover, a person skilled in the art will appreciate the functions, operations, configurations, and details, e.g., shapes and/or construction, of the lenses discussed herein, and thus a detailed discussion of the same is omitted herein for the sake of brevity.

Lenses of the present embodiments can be additively manufactured by controlling or tuning a dielectric constant thereof. In some embodiments, the effective Dk can be controlled by tuning or varying the volume fraction of solid-to-air constantly across the volume of the lens envelope. Varying the volume fraction can result in formation of superstrates having non-uniform dielectric constants across a body thereof, e.g., formation of an anisotropic material in a given direction, such as the z-direction. Alternatively, in some embodiments, the dielectric constant can be tuned to a uniform value across the superstrate. For example, lenses in which the dielectric constant does not vary across a body thereof, e.g., constant-K lenses 700, as shown in FIG. 6, can include a lens in which the Dk is uniform across the lens 700. As shown, the constant-K lens 700, which is pictured paired with a balanced antipodal Vivaldi antenna 710, can use a single material, e.g., a photopolymer resin with a dielectric constant of about 2.8 Dk, in conjunction with the gyroid latticing approach to enable any number of constant-k dielectric lenses by changing the volume fraction of solid-to-air constantly across the volume of the lens envelope.

The ability to control the dielectric constant can allow the lenses of the present embodiments to mimic properties of another material, as discussed above. For example, in the constant-K lens of FIG. 6, the lens can be manufactured to behave similarly to Teflon, which has a Dk value of 3.2, despite using a photopolymer resin with a dielectric constant of about 2.8 Dk, by varying the volume fraction of the entire device to match the dielectric of Teflon for a particular frequency of interest.

In some embodiments, thin, solid dielectric skins can be created on the surfaces of the lenses of the present embodiments. These skins can protect the lattice structures of the superstrates, while becoming a landing area for metallization.

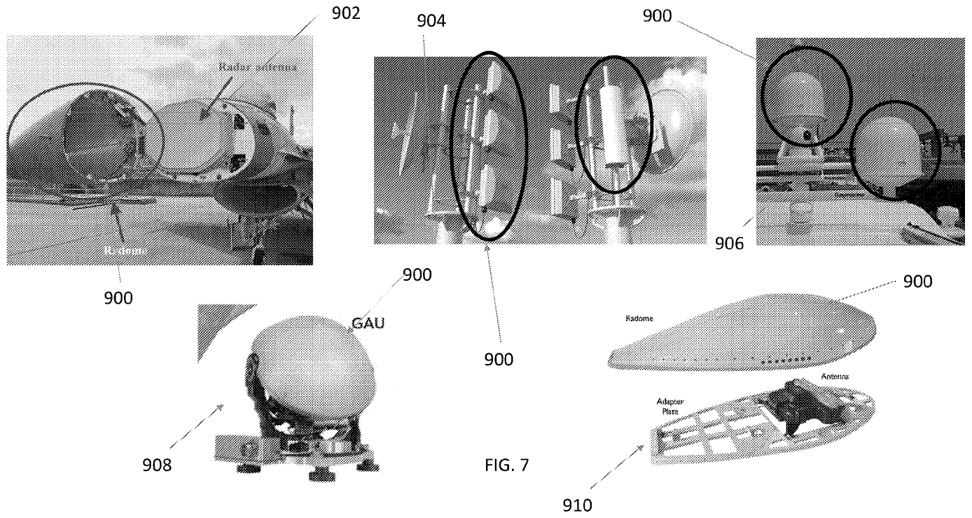

Another example of the more complex shapes of the superstrates 600 of the present embodiments having a curved shape can occur with respect to the manufacture of radomes. A person skilled in the art will recognize that radomes, and nosecones, which are a type of radome, can be used to protect an antenna and are typically made from transparent and/or transparent RF materials, which can function as housings that affect the behavior of electromagnetic (EM) signals, or EM waves, that pass through them in a designated manner. Some non-limiting examples of structures that can include radomes 900 can be: a nosecone on an commercial aircraft radar antennae 902; telecommunication towers 904; maritime radar 906; commercial satellite communication (SATCOM) antennae 908; unmanned aerial vehicle (UAV) 910; and the like, which are shown by way of non-limiting examples of the same in FIG. 7. In conventional embodiments, though RF engineers typically consider the impact of the radome on the EM signal, and account for it in design, the radome plays no active role in the function of the electromagnetics of the antenna. Using the techniques of the present embodiments, different structures can be integrated into the body of the radome to intentionally add function thereto. For example, in some embodiments, the radome can be modified to better match to air, e.g., free space, and/or have lensing capabilities integrated into the radome. The superstrates 600 of the present embodiments can be applied to any of these types of radomes by a person skilled in the art in view of the present disclosures. Moreover, a person skilled in the art will appreciate the functions, operations, configurations, and details, e.g., shapes and/or construction, of the radomes discussed herein, and thus a detailed discussion of the same is omitted herein for the sake of brevity.

The techniques herein allow for the ability to compress layers of highly viscous material and to continuously mix the material, keeping it homogeneous. Having a material in a photocurable polymer that meets the specifications of the machine and is low-loss also enables the strong performance of the superstrates, and thus related components including such superstrates (e.g., antenna).

The gyroid structures, superstrates, and related components (e. g. antennas, lenses) provided for herein can be produced by some additive manufacturing printers, such as a vat polymerization-based printer. The printers should generally have the ability to print a low-loss RF material in specialized shapes, like the gyroid shape and/or the lenses, among other structures, discussed above. Additional disclosures about printing gyroid shapes in conjunction with Additive Manufactured Dielectric Foams (AMDFs) is provided for in the contemporaneously filed application related to AMDFs, entitled “Additive Manufactured Dielectric Foams and Methods for Producing the Same,” the contents of which is incorporated by reference herein in its entirety. A person skilled in the art will understand how those principles can be used in conjunction with manufacturing superstrates as well. More particularly, in at least some aspects of the present disclosure, the printed structures, that is the superstrates, take the form of large panels of varying lattices that are similar to the AMDFs described in the aforementioned provisional patent application, but the superstrates having one or more discrete layers of dielectric. In some embodiments, the superstrates 600 of the present embodiments can form the AMDF, the radome, and/or the lenses in an RF device.

More particularly, FIGS. 8A and 8B illustrate one exemplary embodiment of a FLUX CORE 3D printer 10 that can be used to form the gyroid structures, superstrates, and related components (e.g., steerable antenna) disclosed herein or otherwise derivable from the present disclosures. A printer like the FLUX CORE 3D printer 10 provides useful abilities for these purposes because the printer is able to compress layers of highly viscous materials, and it is also able to continuously mix the material, keeping it homogeneous. Materials that can be used to form the gyroid structures, and thus the superstrate, can include a photocurable polymer that meets the specifications of the printer with which the material is being used and is generally considered to be a low-loss material. One non-limiting example of such material includes Radix™ printable dielectric material (e.g., 2.8 Dk), provided by Rogers Corporation (Chandler, AZ).

The printer 10 includes an outer casing or housing 20 in which various components of the printer 10 are disposed. The FLUX CORE 3D printer is designed to use a bottom-up printing technique, and thus includes a build plate 30 that can be advanced vertically, substantially parallel to a longitudinal axis L of the printer 10 such that the build plate 30 can be moved vertically away from a print reservoir 50 in which resin to be cured to form a desired part, such as resins as provided for above, is disposed. Generally, the build plate 30 can be advanced up and down with respect to a linear rail 32 as desired, the linear rail 32 being substantially colinear with the longitudinal axis L. As a result, the rail 32 can be considered a vertical rail. The build plate 30 can be associated with the linear rail 32 by way or one or more coupling components, such as arm or armatures 34, guides 36, 38, and/or other structures known to those skilled in the art for creating mechanical links that allow one component to move with respect to another.

As described herein, as the build plate 30 moves away from the print reservoir 50, the resin is cured to the build plate 30 and/or to already cured resin to form the printed part in a layer-by-layer manner as the build plate 30 advances away from the reservoir 50. The resin is cured, for example, by a light source and/or a radiation source, as shown a digital light projector 60. The reservoir 50 can include a glass base 52 to allow the digital light projector 60 to pass light into the reservoir 50 to cure the resin. The glass base 52 can more generally be a transparent platform through which light and/or radiation can pass to selective cure the resin. Resin can be introduced to the printer 10 by way of a materials dock 54 that can be accessible, for example via a drawer 22, formed as part of the housing 20.

One or more mixers can be included to help keep the resin viscous and homogeneous. More particularly, at least one mixer, as shown an external mixer 80, can be in fluid communication with the print reservoir 50 to allow resin to flow out of the reservoir 50, into the mixer 80 to be mixed, and then flow back into the reservoir 50 after it has been mixed by the mixer 80. The mixer 80 can be accessible, for example, via a front panel door 24 provided as part of the housing 20. At least one heating element 82 can be included for use in conjunction with the mixer 80 such that the treated (i.e., mixed) resin is also heated. In the illustrated embodiment the heating element 82 is disposed proximate to the print reservoir 50, heating the resin after it has been mixed by the mixer 80, although other location are possible, including but not limited to being incorporated with the mixer 80 to heat and mix simultaneously and/or consecutively. The resin can be heated more than once by additional heating elements as well. Resin that travels from the reservoir 50, to the mixer 80, and back to the reservoir 50 can flow through any number of conduits or tubes configured to allow resin to travel therethrough, such as the conduits 84 illustrated in FIG. 8B.

The resin can also flow through a reservoir manifold 56, which can be disposed above the print reservoir 50. The manifold 56 can serve a variety of purposes, including but not limited to helping to maintain the position of the reservoir 50 during operation, and helping to facilitate mechanical, electrical, and fluid connections between the reservoir and other components of the printer 10. For example, the manifold can be designed to allow resin to be mixed and/or heated to flow out of the reservoir 50, as well as allow mixed and/or heated resin to flow into the reservoir 50 via ports formed therein. Electrical connections to help operate various features associated with the reservoir 50, such as monitoring of a level of resin and/or monitoring an orientation of one or more components disposed and/or otherwise situated with respect to the reservoir 50, can be passed through the manifold 56. The electrical connections may be associated with various electronics and the like housed within the printer 10, for example in an electronics panel 90. Additional details about a reservoir manifold are provided for in International Patent Application No. WO 2021/217102, entitled “Manifold and Related Methods for Use with a Reservoir for Additive Manufacturing,” the contents of which is incorporated by reference herein in its entirety.

A touch screen 26 or other user interface can be included as part of the housing 20 to allow a user to input various parameters for a print job and/or for instructions, signals, warnings, or other information to be passed along by any systems of the printer 10 to a user. Still further, the housing 20 can include an openable and/or removable hood 28 that enables a printed part, as well as components of the printer 10, to be accessed. The hood 28 can also include a viewing portion, such as a window 29, that allows a user to view a print job being performed. As shown, the build plate 30, and thus a part being printed that will be attached to the build plate 30, can be seen through the window 29. Further, the reservoir 50, manifold 56, and other components of the printer 10 can also be visible through the window 29.

In use, the gyroid structures and/or superstrates can be produced using printers like the printer 10 by first creating a design for the gyroid structure and/or the superstrates. In an instance in which the superstrate is going to be used in conjunction with an RF device, such as an antenna, an RF design engineer can design an impedance matching structure with simulation software to improve reflection at wide angles for an existing phased array antenna solution. The data can be output, for example, in the form of a point field, with each point carrying values for spatial location (x, y, z) and effective Dk per the range available for a given base material. The resulting design can be converted to a lattice structure, which in turn can be printed by the printer. Additive manufacturing processes can be carried out, including the layer-by-layer production of the superstrate, complete with processing, cleaning, and UV curing actions. The resulting device can be installed, for example, over phased array apertures of an antenna.

Examples of the above-described embodiments can include the following:
1. A low-loss, lattice-based superstrate, comprising:
   a plurality of layers that comprise a mix of low-loss dielectric material and air,
   wherein dielectric constant values for a single layer of the plurality of layers is varied by way of a volume fraction of the mix of low-loss dielectric material and air across a volume of the superstrate, and
   wherein dielectric constant values for the superstrate are varied across a volume of the superstrate by way of the volume fraction of the mix of low-loss dielectric material and air.
2. The superstrate of claim 1, wherein the superstrate comprises a plurality of discrete regions, each region of the plurality of discrete regions having a different dielectric constant value.
3 The superstrate of claim 1 or claim 2, wherein the plurality of layers form a lens configured to be paired with a radio frequency device.
4. The superstrate of claim 3, wherein the lens is a gradient refractive index (GRIN) dielectric lens.
5. The superstrate of claim 3 or claim 4, wherein the lens is configured to be enhance or manipulate a strength of a beam to which the lens is coupled.
6. The superstrate of any of claims 1 to 5, further comprising a solid skin coupled to at least a portion of a periphery of the plurality of layers.
7. The superstrate of claim 6, wherein the solid skin provides a landing area for metallization.
8 The superstrate of any of claims 1 to 7, wherein the superstrate has an arcuate outer layer having a radius of curvature.
9. The superstrate of any of claims 1 to 8, wherein the superstrate is configured to provide wide-angle impedance matching (WAIM) superior to that of a traditional wide angle matching superstrate.
10. The superstrate of claim 9, wherein a scan angle of a phased array that includes the superstrate is at least about 70 degrees from boresight.
11. The superstrate of any of claims 1 to 10, wherein an effective relative permittivity rate of the superstrate is approximately in the range of about 1.1 to about 2.1.
12. The superstrate of any of claims 1 to 11, wherein an effective relative permittivity rate of the superstrate is approximately 1.15 or lower.
13. The superstrate of claim 12, wherein an effective relative permittivity rate of the superstrate is approximately 1.1 or lower.
14. The superstrate of any of claims 1 to 13, wherein an effective dielectric value of the superstrate is approximately in the range of about 1.1 Dk to about 2.8 Dk.
15. The superstrate of any of claims 1 to 14, wherein the superstrate is configured to withstand a temperature of at least about 250 °C.
16. The superstrate of any of claims 1 to 15, wherein each layer of the plurality of layers is formed from a plurality of gyroid structures.
17. The superstrate of any of claims 1 to 16, wherein the dielectric constant values for the superstrate form a uniform value across the plurality of layers.
18. A method for printing a superstrate, comprising:
   additively manufacturing a superstrate that comprises a plurality of layers that comprise a mix of low-loss dielectric material and air, the superstrate being a lens,
   wherein dielectric constant values for a single layer of the plurality of layers are varied by way of a volume fraction of the mix of low-loss dielectric material and air across a volume of the plurality of layers, and
   wherein dielectric constant values for the superstrate are varied across a volume of the superstrate by way of the volume fraction of the mix of low-loss dielectric material and air.
19. The method of claim 18, wherein additively manufacturing the superstrate further comprises forming a plurality of discrete regions of the superstrate, each region of the plurality of discrete regions having a different dielectric constant value.
20. The method of claim 18 or claim 19, wherein dielectric constant values for the superstrate are varied across the volume of the superstrate further comprises matching the dielectric constant values for the superstrate to a dielectric constant values of a material for a frequency of interest.
21. The method of any of claims 18 to 20, wherein the dielectric constant values for the superstrate form a uniform value across the plurality of layers.
22. The method of any of claims 18 to 21, further comprising placing the lenses in front of a generated beam to enhance or manipulate a strength of the beam.
23. The method of any of claims 18 to 22, wherein additively manufacturing a superstrate further comprises varying an effective dielectric constant value of the superstrate by using gyroids having different dielectric constant values at different locations of the plurality of gyroid layers.

24. The method of any of claims 18 to 23, wherein the superstrate has an arcuate outer layer having a radius of curvature.
25. The method of any of claims 18 to 24, further comprising:
   coupling a solid skin to at least a portion of a periphery of the plurality of layers of the superstrate.

26. The method of any of claims 18 to 26, wherein dielectric constant values for the plurality of layers transition along an effective gradient that tapers continuously across the plurality of layers.
27. The method of any of claims 18 to 26, wherein dielectric constant values for the superstrate transition along an effective gradient that tapers continuously across the substrate.

One skilled in the art will appreciate further features and advantages of the present disclosure based on the above-described embodiments. Accordingly, the disclosure is not to be limited by what has been particularly shown and described. Further, a person skilled in the art, in view of the present disclosures, will understand how to implement the disclosed systems and methods provided for herein in conjunction with at least vat polymerization printers, including SLA-style and DLP-style additive manufacturing printers. All publications and references cited herein are expressly incorporated herein by reference in their entireties.

Some non-limiting claims are provided below.

What is claimed is:

1. A low-loss, lattice-based superstrate, comprising:
a plurality of layers that comprise a mix of low-loss dielectric material and air,
wherein dielectric constant values for a single layer of the plurality of layers is varied by way of a volume fraction of the mix of low-loss dielectric material and air across a volume of the superstrate, and
wherein dielectric constant values for the superstrate are varied across a volume of the superstrate by way of the volume fraction of the mix of low-loss dielectric material and air.

2. The superstrate of claim 1, wherein the superstrate comprises a plurality of discrete regions, each region of the plurality of discrete regions having a different dielectric constant value.

3. The superstrate of claim 1, wherein the plurality of layers form a lens configured to be paired with a radio frequency device.

4. The superstrate of claim 3, wherein the lens is a gradient refractive index (GRIN) dielectric lens.

5. The superstrate of claim 3, wherein the lens is configured to be enhance or manipulate strength of a beam to which the lens is coupled.

6. The superstrate of claim 1, further comprising a solid skin coupled to at least a portion of a periphery of the plurality of layers.

7. The superstrate of claim 6, wherein the solid skin provides a landing area for metallization.

8. The superstrate of claim 1, wherein the superstrate has an arcuate outer layer having a radius of curvature.

9. The superstrate of claim 1, wherein the superstrate is configured to provide wide-angle impedance matching (WAIM) superior to that of a traditional wide angle matching superstrate.

10. The superstrate of claim 9, wherein a scan angle of a phased array that includes the superstrate is at least about 70 degrees from boresight.

11. The superstrate of claim 1, wherein an effective relative permittivity rate of the superstrate is approximately in the range of about 1.1 to about 2.1.

12. The superstrate of claim 1, wherein an effective relative permittivity rate of the superstrate is approximately 1.15 or lower.

13. The superstrate of claim 12, wherein an effective relative permittivity rate of the superstrate is approximately 1.1 or lower.

14. The superstrate of claim 1, wherein an effective dielectric value of the superstrate is approximately in the range of about 1.1 Dk to about 2.8 Dk.

15. The superstrate of claim 1, wherein the superstrate is configured to withstand a temperature of at least about 250 °C.

16. The superstrate of claim 1, wherein each layer of the plurality of layers is formed from a plurality of gyroid structures.

17. The superstrate of claim 1, wherein the dielectric constant values for the superstrate form a uniform value across the plurality of layers.

18. A method for printing a superstrate, comprising:
additively manufacturing a superstrate that comprises a plurality of layers that comprise a mix of low-loss dielectric material and air, the superstrate being a lens,
wherein dielectric constant values for a single layer of the plurality of layers are varied by way of a volume fraction of the mix of low-loss dielectric material and air across a volume of the plurality of layers, and
wherein dielectric constant values for the superstrate are varied across a volume of the superstrate by way of the volume fraction of the mix of low-loss dielectric material and air.

19. The method of claim 18, wherein additively manufacturing the superstrate further comprises forming a plurality of discrete regions of the superstrate, each region of the plurality of discrete regions having a different dielectric constant value.

20. The method of claim 18, wherein dielectric constant values for the superstrate are varied across the volume of the superstrate further comprises matching the dielectric constant values for the superstrate to a dielectric constant values of a material for a frequency of interest.

21. The method of claim 18, wherein the dielectric constant values for the superstrate form a uniform value across the plurality of layers.

22. The method of claim 18, further comprising placing the lenses in front of a generated beam to enhance or manipulate a strength of the beam.

23. The method of claim 18, wherein additively manufacturing a superstrate further comprises varying an effective dielectric constant value of the superstrate by using gyroids having different dielectric constant values at different locations of the plurality of gyroid layers.

24. The method of claim 18, wherein the superstrate has an arcuate outer layer having a radius of curvature.

25. The method of claim 18, further comprising:
coupling a solid skin to at least a portion of a periphery of the plurality of layers of the superstrate.

26. The method of claim 18, wherein dielectric constant values for the plurality of layers transition along an effective gradient that tapers continuously across the plurality of layers.

27. The method of claim 18, wherein dielectric constant values for the superstrate transition along an effective gradient that tapers continuously across the substrate.
